(19) United States
(12) Patent Application Publication
(10) Pub. No.: US 2011/0148726 A1
(43) Pub. Date: Jun. 23, 2011

(54) DUAL BAND ANTENNA

(76) Inventors: Jin-Su CHANG, Hsinchu County (TW); Kuo-Chang Lo, Miaoli County (TW)

(21) Appl. No.: 12/869,144

(22) Filed: Aug. 26, 2010

(30) Foreign Application Priority Data
Dec. 23, 2009 (TW) 098144532

(51) Int. Cl. H01Q 5/01; H01Q 13/10

(52) U.S. Cl. 343/770

(57) ABSTRACT

A dual band antenna includes a grounding portion, a connection portion, a radiating portion, a radiating groove and a feeding portion. The connection portion has a top side and a bottom side disposed relatively, and has a first edge side and a second edge side connected to the top side and the bottom side. The bottom side of the connecting portion is connected with the grounding portion. The radiation portion is protruded from the first edge side of the connecting portion and neighboring to the top side of the connecting portion. The radiation groove is disposed on the inside of the connecting portion and neighboring to the second edge side and bottom side of the connecting portion, and has a opening located on the first edge side of the connecting portion. The feeding portion is formed on the connecting portion and neighboring to the opening of the radiation groove. The radiation portion is operated at a first band width and the radiation groove is operated at a second band width to make the dual band antenna of this invention work in two different bands.

### CROSS REFERENCE TO RELATED APPLICATIONS

This Non-provisional application claims priority under 35 U.S.C. §119(a) on Patent Application No(s). 098144532 filed in the Republic of China on Dec. 23, 2009, the entire contents of which are hereby incorporated by reference.

### BACKGROUND OF THE INVENTION

1. Field of Invention

The present invention relates to an antenna and, in particular, a dual band antenna.

2. Related Art

An antenna is an important element of wireless communication system for transmitting and receiving electromagnetic waves. Without the antenna, the wireless communication system cannot operate effectively. Recently, the most common regulations of bands are for example IEEE 802.11, DECT and the most popular 802.15.1 (Bluetooth communication). In more detailed, 802.11 can be classified as 802.11a and 802.11b specifically defined for 5 GHz and 2.4 GHz, respectively.

FIG. 1 is a schematic figure of a conventional antenna 1. As shown in FIG. 1, the antenna 1 includes a radiating portion 11, a short circuit portion 12, a feeding portion 13 and a grounding portion 14. The short circuit portion 12 is disposed at an edge side of the radiating portion 11 and electrically connected to the grounding portion 14. The feeding point of the radiating potion 11 is connected to the feeding portion 13 to feed the grounding portion such that the antenna 1 is formed.

Accordingly, the antenna 1 can generate resonance at the radiating portion 11 by a current provided on the feeding portion 13, so that it can receive or transmit a signal of a specific band width defined by the generated resonance. In addition, a radiating metal sheet (not shown) may be configured on the radiating portion 11, which may allow the antenna 1 to function as a dual-band antenna.

However, the band width provided by the antenna 1 covers one limited range, and cannot support other needed band width(s). Unfortunately, if the antenna 1 is configured with the extra radiating metal sheet, the entire size of the antenna 1 can not be sufficiently reduced, so that it may not be applied to the latest miniaturized electronic products.

Therefore, it is an important subject of the invention to provide a multi-band antenna with small size.

### SUMMARY OF THE INVENTION

In view of the foregoing, the present invention is to provide a multi-band antenna with small size.

To achieve the above, an antenna in accordance with the present invention includes a grounding portion, a connection portion, a radiating portion and a feeding portion. The connection portion has a top side, a bottom side, a first edge side and a second edge side. The top side is disposed opposite to the bottom side, and the first edge side and the second edge side are connected to two ends of the top side and the bottom side respectively. The bottom side of the connection portion is connected to the grounding portion. The radiating portion is protruded from the first edge side of the connection portion and disposed adjacent to the top side of the connection portion. The radiating groove is formed in the inside of the connection portion and disposed adjacent to the second edge side and the bottom side of the connection portion. The radiating groove has an opening located at the first edge side of the connection portion. The feeding portion is formed on the connection portion and adjacent to the opening of the radiating groove. The radiating portion is operated at a first band width, and the radiating groove is operated at a second band width. Accordingly, the dual band antenna can be operated at two different band widths.

In one embodiment of the present invention, the above-mentioned feeding portion is connected to a signal source.

In one embodiment of the present invention, the aforementioned connection portion further has a positioning groove disposed adjacent to the radiating groove and the first edge side of the connection portion to position the feeding portion adjacent to the positioning groove.

In one preferred embodiment of the present invention, the aforementioned positioning groove further has an opening toward the radiating groove.

In one embodiment of the present invention, an angle is formed between the aforementioned grounding portion and the connection portion.

In one embodiment of the present invention, the aforementioned connection portion further has a fixing portion protruded from the feeding portion and extending toward the grounding portion through the radiating groove. In addition, the grounding portion has a concave corresponding to the fixing portion such that the dual band antenna can be fixed and then applied in a wireless communication device by the connection portion connected to a signal source.

In one embodiment of the present invention, the aforementioned grounding portion is electrically connected to an additional large-area grounding plane.

In the preferred embodiment of the present invention, the aforementioned top side and the bottom side of the connection portion are disposed in substantial parallel.

In the preferred embodiment of the present invention, the aforementioned bottom side and the first edge side of the connection portion are disposed in substantial verticality.

In the preferred embodiment of the present invention, the aforementioned bottom side and the second edge side of the connection portion are disposed in substantial verticality.

In the preferred embodiment of the present invention, the aforementioned radiating portion is disposed substantially parallel to the grounding portion.

In one embodiment of the present invention, the aforementioned opening of the radiating groove is adjacent to the bottom side of the connection portion.

In one embodiment of the present invention, the aforementioned radiating groove has at least one bending portion and substantially L-shaped.

In the preferred embodiment of the present invention, the aforementioned radiating groove is substantially L-shaped and formed by a first slot, a second slot and the bending portion. One end of the first slot is connected to the bending portion, and the other end of the first slot is enclosed. One end of the second slot is connected to the bending portion, and the other end of the second slot is an opening. The first slot is disposed substantially parallel to the second edge side of the connection portion, and the second slot is disposed substantially parallel to the bottom side of the connection portion.

In one embodiment of the present invention, the aforementioned dual band antenna further includes an impedance matching portion connected to the grounding portion, and an angle is formed between the impedance matching portion and the grounding portion. The impedance matching of the antenna is adjusted by the impedance matching portion.

In the preferred embodiment of the present invention, the aforementioned impedance matching portion is adjacent to the first edge side of the connection portion.

In one embodiment of the present invention, the aforementioned second band width of the operation frequency is higher than the first band width of that.

In one embodiment of the present invention, the aforementioned dual band antenna is integrally formed as one piece.

In one embodiment of the present invention, the aforementioned dual band antenna can further includes a plurality of fixing members protruded from the grounding portion. The dual band antenna can be fixed and then applied in a wireless communication device by the fixing members.

In summary, a dual band antenna in accordance with the present invention has a radiating portion and a radiating groove so as to transmit and receive one signal at one band width (for example from 2.4 GHz to 2.5 GHz) by the radiating portion, and transmit and receive the other signal with the other band width (for example from 5.15 GHz to 5.85 GHz) by the radiating groove. Accordingly, the dual band antenna can be operated at two different operation band widths simultaneously, and one of the operation band widths is generated by the radiating groove. The disposition of the radiating groove significantly reduces the size of the dual band antenna and further miniaturizes the dual band antenna.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic figure of a conventional antenna;

FIG. 2A is a schematic figure of a dual band antenna 2 in accordance with a preferred embodiment of the present invention, and FIG. 2B is a top view of a sheet forming the dual band antenna 2 shown in FIG. 2A;

FIG. 3 is a measurement figure illustrating the relation of the frequency of the dual band antenna 2 and voltage static wave ratio in accordance with the present embodiment;

FIG. 4A to FIG. 4E are the results of radiation pattern measurement of XY-Plane when the dual band antenna in accordance with the preferred embodiment of the present invention is operated at different band widths; and

FIG. 5A is a schematic figure of another aspect of the dual band antenna 2a in accordance with the preferred embodiment of the present invention, and FIG. 5B is a top view of a sheet forming the dual band antenna 2a showing in FIG. 5A.

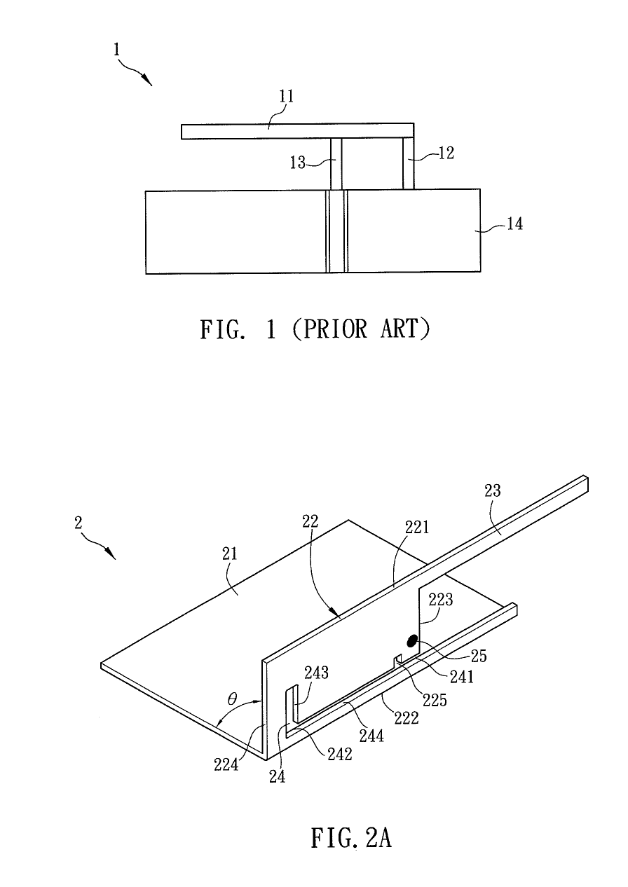

### DETAILED DESCRIPTION OF THE INVENTION

The present invention will be apparent from the following detailed description, which proceeds with reference to the accompanying drawings, wherein the same references relate to the same elements.

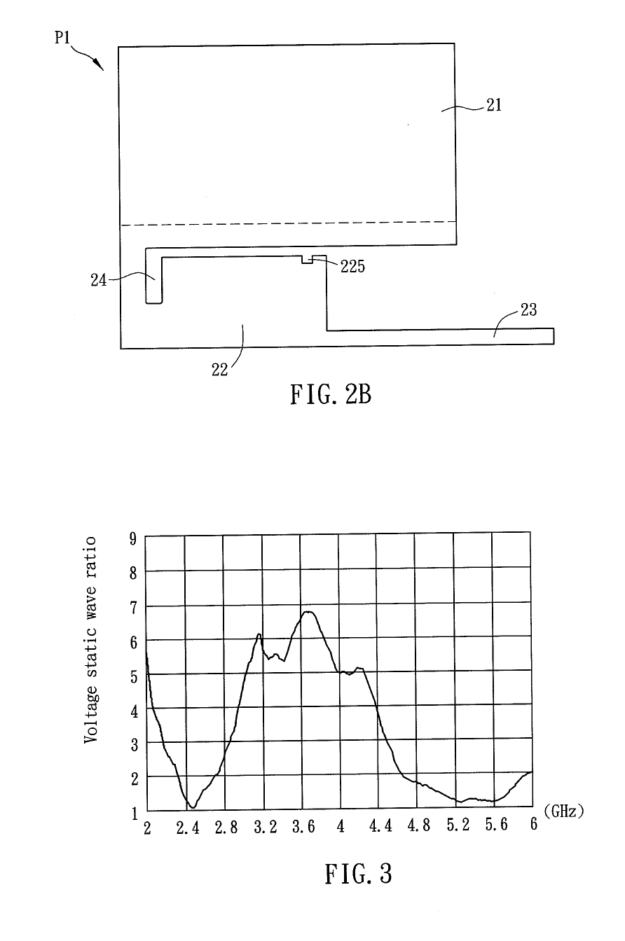

FIG. 2A is a schematic figure of a dual band antenna 2 in accordance with a preferred embodiment of the present invention. As shown in FIG. 2A, the dual band antenna 2 includes a grounding portion 21, a connection portion 22, a radiating portion 23, a radiating groove 24 and a feeding portion 25. The material of the dual band antenna 2 can be for example metal or other conductive material.

The grounding portion 21 is for example but not limited to rectangular. Certainly, in accordance with different needs or designs, the grounding portion 21 can also be square-shaped or other polygon-shaped. To be noted, the size of the grounding portion 21 is not limited. In practice, the preferred size of the grounding portion 21 is for example but not limited to approximately 35 mm×22.6 mm.

The connection portion 22 has a top side 221, a bottom side 222, a first edge side 223 and a second edge side 224. The top side 221 is disposed opposite to the bottom side 222, and the first edge side 221 and the second edge side 222 are connected to two ends of the top side 221 and the bottom side 222 respectively. An angle θ is formed between the grounding portion 21 and the connection portion 22, and the degree of the angle θ is not limited. In the present embodiment, the connection portion 22 vertically disposed on one edge side of the grounding portion 22 is taken for exemplary description. In other words, the connection portion 22 is vertically disposed (θ=90 degrees) on the edge side of the grounding portion 21. Additionally, the height of the connection portion 22 is not limited. In practice, the preferred height of the connection portion 22 is for example but not limited to approximately 12 mm.

The radiating portion 23 is protruded from the first edge side 223 of the connection portion 22 and disposed adjacent to the top side 221 of the connection portion 22. If the precise signal transmission and reception at a predetermined band width (for example at 2.4 GHz to 2.5 GHz) have been considered, the length of the radiating portion 23 is not limited.

The radiating groove 24 is formed in the inside of the connection portion 22 and disposed adjacent to the second edge side 224 and the bottom side 222 of the connection portion 22. The radiating groove 24 has an opening 241 located at the first edge side 223 of the connection portion 22. In more detailed, the radiating groove 24 can further has at least a bending portion 242. In the present embodiment, the radiating groove 24 formed by a first slot 243, a second slot 244 and the bending portion 242 is taken for exemplary description but not being limited. One end of the first slot 243 is connected to the bending portion 242, and the other end of the first slot 243 is enclosed. One end of the second slot 244 is connected to the bending portion 242, and the other end of the second slot 244 is an opening 241. Additionally, the first slot 243 is disposed substantially parallel to the second edge side 224 of the connection portion 22, and the second slot 244 is disposed substantially parallel to the bottom side 222 of the connection portion 22.

Certainly, if the precise signal transmission and reception of the radiating groove 24 at a predetermined band width (for example at 5.15 GHz to 5.85 GHz) have been considered, the radiating groove 24 can further has extra bending portions.

The feeding portion 25 can be connected to for example a coaxial transmission line to transmit or receive signals at different band widths. In addiction, the connection portion 22 can further has a positioning groove 225 disposed adjacent to the radiating portion 24 and the first edge side 223 of the connection portion 22. The feeding portion 25 can be precisely positioned by the disposition of the positioning groove 225.

It is worth mentioning that the dual band antenna 2 can be integrally formed as one piece or assembled by a plurality of sheets. In the present embodiment, the antenna 2 integrally formed as one piece is taken for exemplary description. FIG. 2B is a top view of a sheet P1 forming the dual band antenna 2. As shown in FIG. 2B, after trimmed into the illustrated shape, the sheet P1 can be folded along the dotted line to form the dual band antenna 2.

As shown in FIG. 2A, accordingly, the dual band antenna 2 can generate resonance at the radiating portion 23 and the radiating groove 24 by a current provided on the feeding portion 25, and then transmit or receive signals at predetermined band widths (for example, the band width of the radiating portion is from 2.4 GHz to 2.5 GHz, and the band width of the radiating groove is from 5.15 GHz to 5.85 GHz) by corresponding band widths generated from the resonance. Accordingly, the dual band antenna 2 can be operated at two different operation band widths simultaneously, and one of the operation band widths is generated by the radiating groove 24. The disposition of the radiating groove 24 significantly reduces the size of the dual band antenna 2 and further miniaturizes the dual band antenna 2.

FIG. 3 is a measurement figure illustrating the relation of the frequency of the dual band antenna 2 and voltage static wave ratio (VSWR) in accordance with the present embodiment. As shown in FIG. 3, the vertical axis indicates voltage static wave ratio (VSWR), and the horizontal axis indicates frequency. The acceptable voltage static wave ratio in industry is approximately 2. However, in the present embodiment, even if the voltage static wave ratio is less than 2, the dual band antenna 2 still can be operated at 2.4 GHz to 2.5 GHz and at 5.15 GHz to 5.85 GHz.

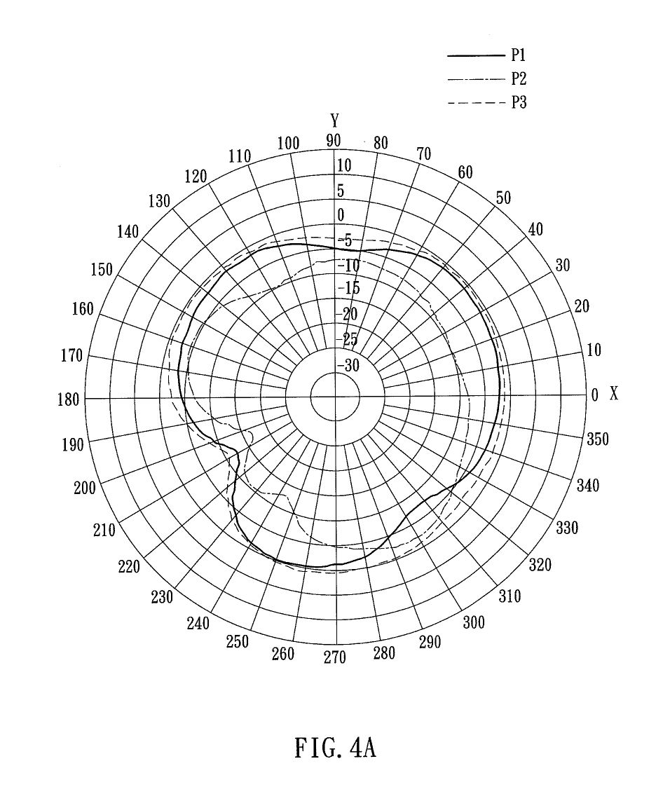

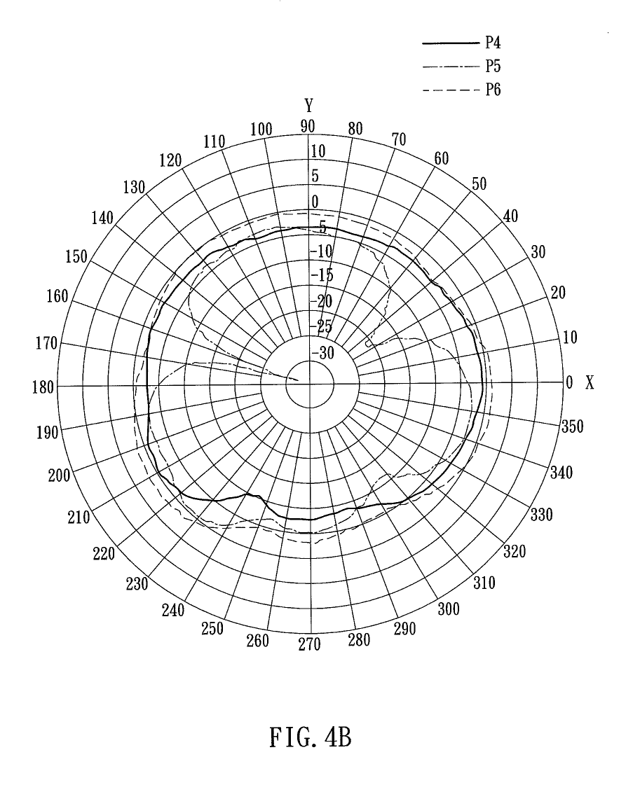

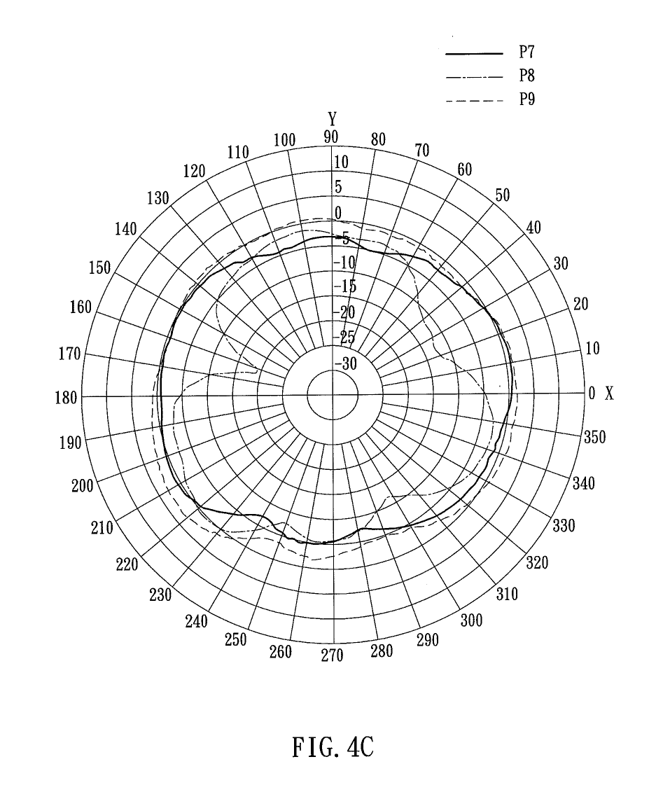

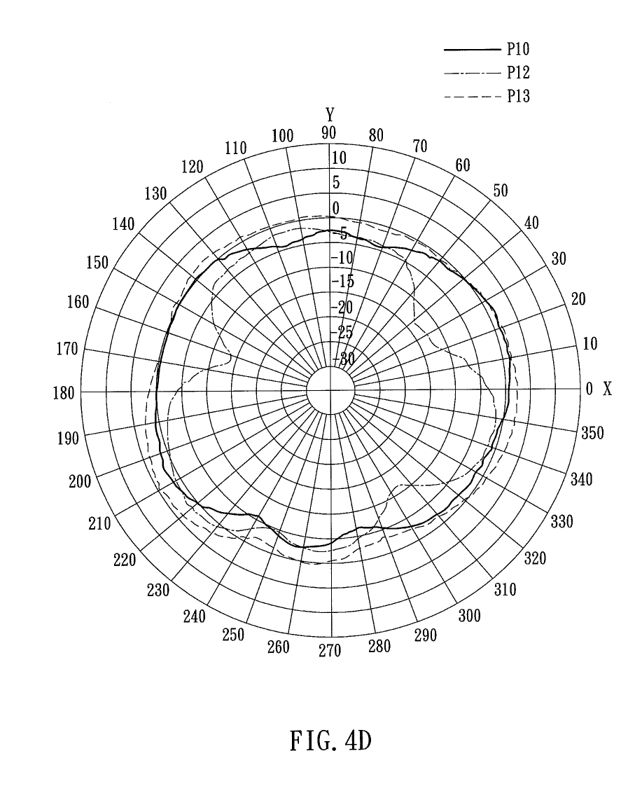

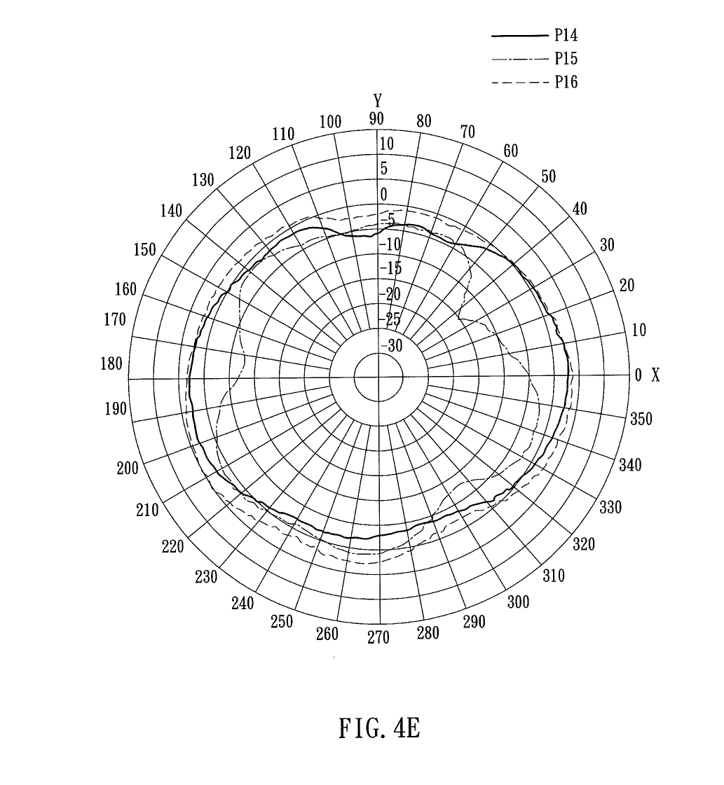

FIG. 4A is the result of radiation pattern measurement of XY-Plane when the dual band antenna 2 in accordance with the present embodiment is operated at 2.45 GHz. As shown in FIG. 4A, the curve P1 indicates the peak amplification is about −0.34 dBi with the angle of 252 degrees and the average amplification is about −3.14 dBi with the angle of 210 degrees when the dual band antenna 2 is operated at 2.45 GHz. The curve P2 indicates the peak amplification is about −2.35 dBi with the angle of 297 degrees and the average amplification is about −7.06 dBi with the angle of 204 degrees when the dual band antenna 2 is operated at 2.45 GHz. The curve P3 indicates the peak amplification is about 0.41 dBi with the angle of 261 degrees and the average amplification is about −1.66 dBi with the angle of 208 degrees when the dual band antenna 2 is operated at 2.45 GHz.

FIG. 4B is the result of radiation pattern measurement of XY-Plane when the dual band antenna 2 in accordance with the present embodiment is operated at 5.15 GHz. As shown in FIG. 4B, the curve P3 indicates the peak amplification is about −0.74 dBi with the angle of 210 degrees and the average amplification is about −3.39 dBi with the angle of 243 degrees when the dual band antenna 2 is operated at 5.15 GHz. The curve P2 indicates the peak amplification is about −0.76 dBi with the angle of 228 degrees and the average amplification is about −5.11 dBi with the angle of 162 degrees when the dual band antenna 2 is operated at 5.15 GHz. The curve P6 indicates the peak amplification is about 1.51 dBi with the angle of 219 degrees and the average amplification is about −1.156 dBi with the angle of 300 degrees when the dual band antenna 2 is operated at 5.15 GHz.

FIG. 4C is the result of radiation pattern measurement of XY-Plane when the dual band antenna 2 in accordance with the present embodiment is operated at 5.35 GHz. As shown in FIG. 4B, the curve P7 indicates the peak amplification is about 0.59 dBi with the angle of 15 degrees and the average amplification is about −2.1 dBi with the angle of 282 degrees when the dual band antenna 2 is operated at 5.35 GHz. The curve P8 indicates the peak amplification is about 0.18 dBi with the angle of 222 degrees and the average amplification is about −4.65 dBi with the angle of 162 degrees when the dual band antenna 2 is operated at 5.35 GHz. The curve P9 indicates the peak amplification is about 2.77 dBi with the angle of 216 degrees and the average amplification is about −0.18 dBi with the angle of 288 degrees when the dual band antenna 2 is operated at 5.35 GHz.

FIG. 4D is the result of radiation pattern measurement of XY-Plane when the dual band antenna 2 in accordance with the present embodiment is operated at 5.47 GHz. As shown in FIG. 4D, the curve P10 indicates the peak amplification is about 1.51 dBi with the angle of 207 degrees and the average amplification is about −1.35 dBi with the angle of 282 degrees when the dual band antenna 2 is operated at 5.47 GHz. The curve P11 indicates the peak amplification is about 1.49 dBi with the angle of 219 degrees and the average amplification is about −3.6 dBi with the angle of 162 degrees when the dual band antenna 2 is operated at 5.47 GHz. The curve P12 indicates the peak amplification is about 4.1 dBi with the angle of 213 degrees and the average amplification is about 0.68 dBi with the angle of 290 degrees when the dual band antenna 2 is operated at 5.47 GHz.

FIG. 4E is the result of radiation pattern measurement of XY-Plane when the dual band antenna 2 in accordance with the present embodiment is operated at 5.85 GHz. As shown in FIG. 4B, the curve P13 indicates the peak amplification is about 3.27 dBi with the angle of 195 degrees and the average amplification is about 0.02 dBi with the angle of 93 degrees when the dual band antenna 2 is operated at 5.85 GHz. The curve P14 indicates the peak amplification is about 1.55 dBi with the angle of 213 degrees and the average amplification is about −2.73 dBi with the angle of 36 degrees when the dual band antenna 2 is operated at 5.85 GHz. The curve P15 indicates the peak amplification is about 5.08 dBi with the angle of 207 degrees and the average amplification is about 1.87 dBi with the angle of 99 degrees when the dual band antenna 2 is operated at 5.85 GHz.

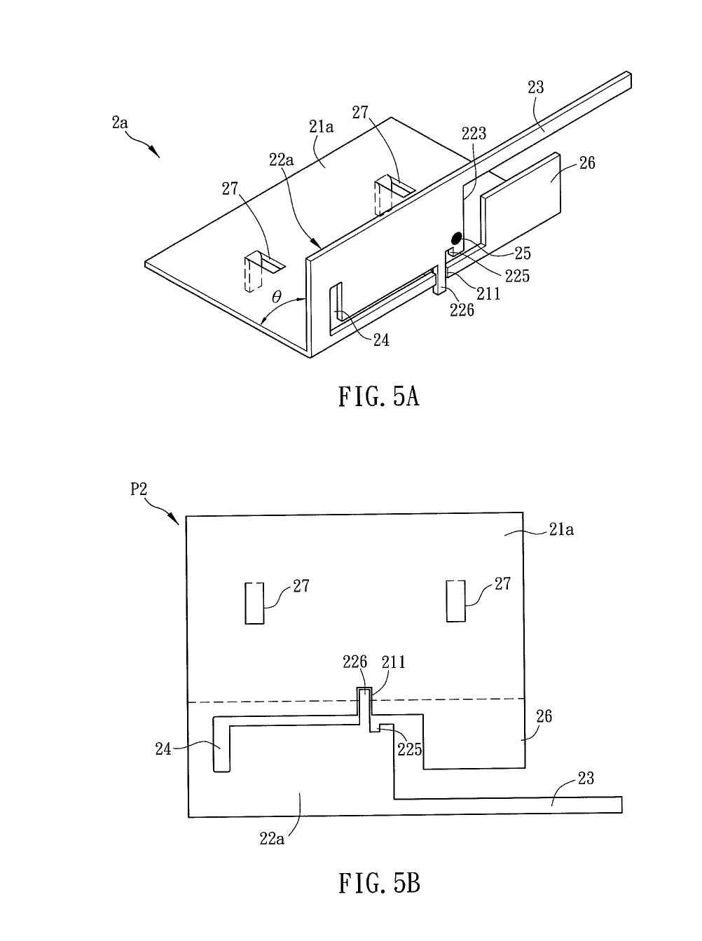

FIG. 5A is a schematic figure of another aspect of the dual band antenna 2a in accordance with the preferred embodiment of the present invention, and FIG. 5B is a top view of the sheet P2 forming the dual band antenna 2a. To be noted, the antenna 2a can be integrally formed as one piece or assembled by a plurality of sheets. Herein, the dual band antenna 2a integrally formed as one piece is taken for exemplary description. As shown in FIG. 5B, after trimmed into the illustrated shape, the sheet P2 can be folded along the dotted line to form the dual band antenna 2a.

The dual band antenna 2a can further include an impedance matching portion 26 connected to the grounding portion, and a angle is formed between the impedance matching portion 26 and the grounding portion 21a. The impedance matching portion 26 is disposed adjacent to the radiating portion 23 and the first edge side 223 of the connection portion 22a. The angle formed between the impedance matching portion 26 and the grounding portion 21a can be equal or unequal to the angle θ. Herein, the angle equal to the angle θ is taken for exemplary description, but not to limit the present invention. Accordingly, the impedance matching of the dual band antenna 2a can be further adjusted by the impedance matching portion. It is worth mentioning that the shape and the size of the impedance matching portion 26 are not limited and can be designed flexibly in accordance with different needs.

In addition, the connection portion 22a can further have a fixing portion 226 protruded from the feeding portion 25 and toward the grounding portion 21 through the radiating groove 24, and the grounding portion 21a has a concave 211 corresponding to the fixing portion 226, and the radiating groove 23 and the impedance matching portion 26 can disposed along the concave 211. Moreover, the dual band antenna 2a can further include a plurality of fixing members 27 protruded from the grounding portion 21a. Accordingly, the dual band antenna 2a can be fixed and then applied in a wireless communication device by the fixing portion 226 and the fixing members 227.

In summary, the dual band antenna in accordance with the present invention has a radiating portion and a radiating groove so as to transmit and receive one signal at one band width (for example from 2.4 GHz to 2.5 GHz) by the radiating portion and the other signal at the other band width (for example from 5.15 GHz to 5.85 GHz) by the radiating groove. Accordingly, the dual band antenna can be operated at two different operation band widths simultaneously, one of which is generated by the radiating groove. The disposition of the radiating groove significantly reduces the size of the dual band antenna so as to achieve the minimization of the dual band antenna.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A dual band antenna, comprising:
a grounding portion;
a connection portion having a top side, a bottom side, a first edge side and a second edge side, wherein the top side is disposed opposite to the bottom side, the first edge side and the second edge side are connected to two ends of the top side and the bottom side respectively, and the bottom side of the connection portion is connected to the grounding portion;
a radiating portion protruded from the first edge side of the connection portion and disposed adjacent to the top side of the connection portion;
a radiating groove formed in the inside of the connection portion and disposed adjacent to the second edge side and the bottom side of the connection portion, wherein the radiating groove has an opening located at the first edge side of the connection portion; and
a feeding portion formed on the connection portion and disposed adjacent to the opening of the radiating groove;
wherein the radiating portion is operated at a first band width, the radiating groove is operated at a second band width, and an angle is formed between the grounding portion and the connection portion.

2. The dual band antenna of claim 1, wherein the connection portion further has a positioning groove disposed adjacent to the radiating groove and the first edge side of the connection portion.

3. The dual band antenna of claim 1, wherein the radiating groove has at least one bending portion.

4. The dual band antenna of claim 1, wherein the radiating groove is substantially L-shaped and formed by a first slot, a second slot and a bending portion, an end of the first slot is connected to the bending portion, the other end of the first slot is enclosed, an end of the second slot is connected to the bending portion, and the other end of the second slot is the opening.

5. The dual band antenna of claim 4, wherein the first slot is disposed substantially parallel to the second edge side of the connection portion, and the second slot is disposed substantially parallel to the bottom side of the connection portion.

6. The dual band antenna of claim 1, further comprising:
an impedance matching portion connected to the grounding portion, wherein an angle is formed between the impedance matching portion and the grounding portion.

7. The dual band antenna of claim 6, wherein the impedance matching portion is disposed adjacent to the radiating portion and the first edge side of the connection portion.

8. The dual band antenna of claim 1, wherein the connection portion further has a fixing portion protruded from the feeding portion and extending toward the grounding portion through the radiating groove.

9. The dual band antenna of claim 8, wherein the grounding portion has a concave corresponding to the fixing portion.

10. The dual band antenna of claim 1, further comprising:
a plurality of fixing members protruded from the grounding portion.

11. The dual band antenna of claim 1 is integrally formed as one piece.

12. A dual band antenna, comprising:
a grounding portion;
a connection portion having a top side, a bottom side, a first edge side and a second edge side, wherein the top side is disposed opposite to the bottom side, the first edge side and the second edge side are connected to two ends of the top side and the bottom side respectively, and the bottom side of the connection portion is connected to the grounding portion;
a radiating portion protruded from the first edge side of the connection portion and disposed adjacent to the top side of the connection portion;
a radiating groove formed in the inside of the connection portion and disposed adjacent to the second edge side and the bottom side of the connection portion, wherein the radiating groove has an opening located at the first edge side of the connection portion; and
a feeding portion formed on the connection portion and disposed adjacent to the opening of the radiating groove;
wherein the radiating portion is operated at a first band width, and the radiating groove is operated at a second band width.

13. The dual band antenna of claim 12, wherein an angle is formed between the grounding portion and the connection portion.

14. The dual band antenna of claim 12, wherein the connection portion further has a positioning groove disposed adjacent to the radiating groove and the first edge side of the connection portion.

15. The dual band antenna of claim 12, wherein the radiating groove is substantially L-shaped and formed by a first slot, a second slot and a bending portion, an end of the first slot is connected to the bending portion, the other end of the first slot is enclosed, an end of the second slot is connected to the bending portion, and the other end of the second slot is the opening.

16. The dual band antenna of claim 15, wherein the first slot is disposed substantially parallel to the second edge side of the connection portion, and the second slot is disposed substantially parallel to the bottom side of the connection portion.

17. The dual band antenna of claim 12, further comprising:
an impedance matching portion connected to the grounding portion, wherein an angle is formed between the impedance matching portion and the grounding portion.

18. The dual band antenna of claim 17, wherein the impedance matching portion is disposed adjacent to the radiating portion and the first edge side of the connection portion.

19. The dual band antenna of claim 12, further comprising:
a plurality of fixing members protruded from the grounding portion.

20. The dual band antenna of claim 12, which is integrally formed as one piece.

21. The dual band antenna of claim 17, wherein the impedance matching portion and the dual band antenna are integrally formed as one piece.
